(19) United States
(12) Patent Application Publication
(10) Pub. No.: US 2004/0201177 A1
(43) Pub. Date: Oct. 14, 2004

(54) Air Cylinder

(76) Inventor: Shan-Ping Huang, Taichung (TW)

Correspondence Address: SHAN-PING HUANG, 58 MA YUAN WEST ST., TAICHUNG, TW

(21) Appl. No.: 10/412,355

(22) Filed: Apr. 9, 2003

(51) Int. Cl. F16J 15/16

(52) U.S. Cl. 277/500

(57) ABSTRACT

An air cylinder has a piston, an inner tube, an outer tube, a cylinder tank, a control valve, an O-ring, a bearing, and an oil seal. The inner tube is inserted in the outer tube. The outer tube is inserted through the cylinder tank. The control valve is disposed on a top end of the inner tube. The bearing is disposed on a bottom of the inner tube. The O-ring encloses the control valve. The oil seal encloses the bearing. A first sealing device is disposed between the outer tube and the control valve to separate the O-ring and the outer tube, and a second sealing device is disposed between the outer tube and the oil seal.

### BACKGROUND OF THE INVENTION

The present invention relates to an air cylinder. More particularly, the present invention relates to an air cylinder which has a first sealing device to seal a spacing between an outer tube and a control valve and a second sealing device disposed between the outer tube and an oil seal.

Referring to FIGS. 1 to 3, a conventional air cylinder has a piston 1, an inner tube 2, an outer tube 3, a cylinder tank 4, a control valve 22, an O-ring 21, a bearing 23, and an oil seal 24. The inner tube 2 is inserted in the outer tube 3. The outer tube 3 is inserted through the cylinder tank 4. The control valve 22 is disposed on a top end of the inner tube 2. The bearing 23 is disposed on a bottom of the inner tube 2. The O-ring 21 encloses the control valve 22. The oil seal 24 encloses the bearing 23. However, the outer tube 3 has capillary apertures so that an air will leak easily.

### SUMMARY OF THE INVENTION

An object of the present invention is to provide an air cylinder which has a first sealing device to seal a spacing between an outer tube and a control valve and a second sealing device disposed between the outer tube and an oil seal so that an air will not leak.

Accordingly, an air cylinder comprises a piston, an inner tube, an outer tube, a cylinder tank, a control valve, an O-ring, a bearing, and an oil seal. The inner tube is inserted in the outer tube. The outer tube is inserted through the cylinder tank. The control valve is disposed on a top end of the inner tube. The bearing is disposed on a bottom of the inner tube. The O-ring encloses the control valve. The oil seal encloses the bearing. A first sealing device is disposed between the outer tube and the control valve to separate the O-ring and the outer tube, and a second sealing device is disposed between the outer tube and the oil seal.

### BRIEF DESCRIPTION OF THE DRAWINGS

FIG. 1 is a sectional assembly view of an air cylinder of the prior art;

FIG. 2 is a partially sectional view of an outer tube and an O-ring of the prior art;

FIG. 3 is a partially sectional view of an outer tube and an oil seal of the prior art;

FIG. 4 is a sectional assembly view of a first sealing device of a preferred embodiment disposed between an outer tube and a control valve; and

FIG. 5 is a sectional assembly view of a second sealing device of a preferred embodiment disposed between an outer tube and an oil seal.

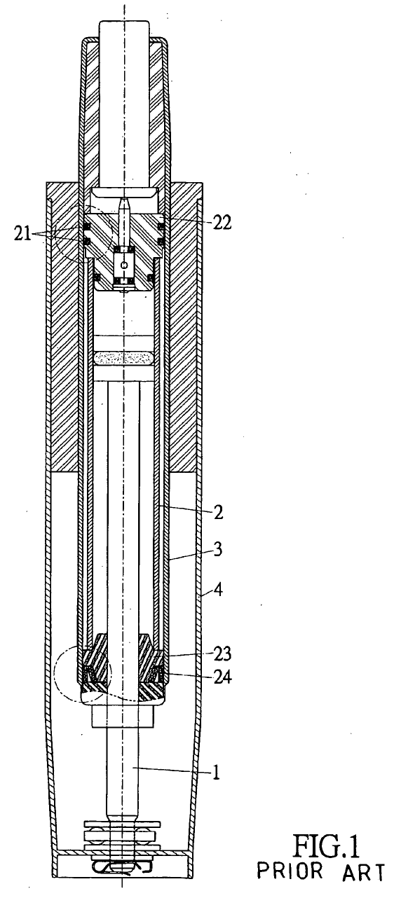

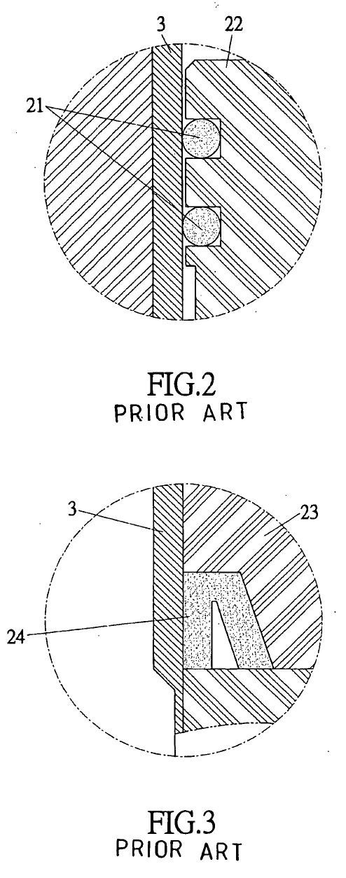

### DETAILED DESCRIPTION OF THE INVENTION

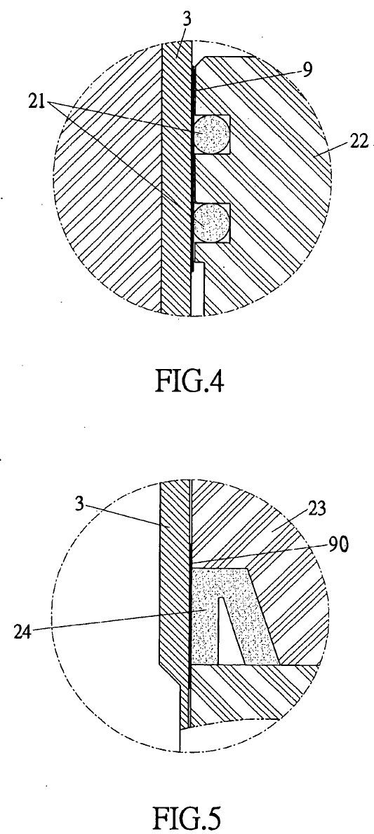

Referring to FIGS. 4 and 5, an air cylinder comprises a first sealing device 9 disposed between an outer tube 3 and a control valve 22 to separate an O-ring 21 and the outer tube 3, and a second sealing device 90 disposed between the outer tube 3 and an oil seal 24.

The first sealing device 9 has an annular shape to be enclosed by an inner wall of the outer tube 3 (not shown in the figure).

The second sealing device 90 has an annular shape to be enclosed by an inner wall of the outer tube 3 (not shown in the figure).

The first sealing device 9 is made of an anticorrosive paint.

The second sealing device 90 is made of an anticorrosive paint.

The present invention has the following advantages.

A spacing which is formed between the outer tube and the control valve is sealed by the first sealing device.

The first sealing device has sealed capillary apertures of the inner wall portion of the outer tube which match the control valve.

The second sealing device has sealed capillary apertures of the inner wall portion of the outer tube which match the oil seal 24.

The present invention is not limited to the above embodiment but various modification thereof may be made. Furthermore, various changes in form and detail may be made without departing from the scope of the present invention.

1. An air cylinder comprises:
a piston, an inner tube, an outer tube, a cylinder tank, a control valve, an O-ring, a bearing, and an oil seal,
the inner tube inserted in the outer tube,
the outer tube inserted through the cylinder tank,
the control valve disposed on a top end of the inner tube,
the bearing disposed on a bottom of the inner tube,
the O-ring enclosing the bearing,
a first sealing device having an annular shape being disposed between an inner wall of the outer tube and the control valve to separate the O-ring and the outer tube so as to form a uniform and smooth first inner face on the inner wall of the outer tube, and
a second sealing device having an annular shape being disposed between the outer tube and the oil seal so as to form a uniform and smooth second inner face on the inner wall of the outer tube.

2. The air cylinder as claimed in claim 1, wherein the first sealing device is made of an anticorrosive paint.

3. The air cylinder as claimed in claim 1, wherein the second sealing device is made of an anticorrosive paint.
